(19) United States
(12) Patent Application Publication
(10) Pub. No.: US 2007/0017997 A1
(43) Pub. Date: Jan. 25, 2007

(54) Suction mounted bar code symbol reading system, apparatus and stand

(76) Inventors: Harry Talley, Woodbury Heights, NJ (US); Matthew Gart, Philadelphia, PA (US)

Correspondence Address: Nancy Smith;Metrologic Instruments, Inc., 90 Coles Road, Blackwood, NJ, 08012-4683, US

(21) Appl. No.: 11/186,710

(22) Filed: Jul. 21, 2005

(51) Int. Cl. G06K 7/10

(52) U.S. Cl. 235/462.43

(57) ABSTRACT

An improved bar code scanner is equipped with a releasable-attachable base for mounting said bar code scanner to a countertop without modifying said countertop. The releasable-attachable base is provided in the form of a suction-cup apparatus. If the suction-cup apparatus is mounted to the countertop, the bar code scanner becomes fixed to the countertop, alleviating the need for a permanent base, which would require modification to the countertop and irreversible damage to the countertop if the permanent base was ever removed due to an equipment upgrade or a change in operational requirements.

### BACKGROUND OF INVENTION

1. Field of the Invention

The present invention relates to a suction mounted bar code symbol reading system, apparatus and stand for use in point-of-sale (POS) and other demanding scanning environments.

2. Brief Description of the Prior Art

Optical bar code symbol reading devices (scanners) of various types have been developed for scanning and decoding bar code symbols. These scanners adapt readily to some operational environments, but present shortcomings when used in other situations. For example, consider system applications involving point-of-sale (POS) terminals in retail stores. Retail POS countertops are prime sales areas, attractive and well-kept countertops will result in increased shopper's confidence during a POS transaction, whereby this confidence may lead to increased customer loyalty and retention.

Existing POS scanners generally fall into one of two general categories: hand-held or stationary. The first category (hand-held) includes manually-actuated trigger-operated scanners, as well as automatically actuated scanners which do not utilize a triggering mechanism. When in use, the user positions the scanner at a specified distance from the object bearing the bar code. In the case of an automatically actuated scanner, the presence of the object is automatically detected, the presence of a bar code symbol on the object is detected, and thereafter the bar code symbol is automatically read. In the case of trigger-operated scanners, the user positions the scanner at a specified distance from an object bearing a bar code symbol, manually activates the scanner to initiate reading and then moves the scanner over the symbol bearing object. When the hand-held scanner is not in use, it is typically housed in a stand device which sits upon the POS countertop. Prior art stand devices of this type are disclosed in U.S. Pat. No. 6,216,951 to Swift; U.S. Pat. No. 6,053,413 to Swift; D427,605 to Schmidt, assigned to the present assignee; D427, 200 to Schmidt, assigned to the present assignee; and D418,500 to Giordano, assigned to the present assignee. However, with reference to prior art stand devices of this type, because they are not rigidly connected to the POS countertop there is an increased likelihood that the stand device might get tipped over, possibly resulting in damage to the scanner.

The second category (stationary) includes countertop mounted scanners, as well as in-counter mounted scanners. In both cases, objects with bar codes thereon are moved to or past the stationary bar code scanner for scanning. In the case of the countertop mounted scanners, the scanners are typically mounted by drilling holes into the POS countertop and bolting the scanner into position. A prior art stationary scanner of this type is disclosed in U.S. Pat. No. 5,216,231 to Ouchi. This scanner is mountable on an adjustable base positioned above a countertop. The base is constructed to permit the scanner housing to be adjusted in any of a variety of directions so that the scanning pattern will be projected at a desired orientation with respect to the countertop. However, the base must be permanently secured to the countertop, which requires modification to the countertop and irreversible damage to the countertop if the scanner system was ever removed due to an equipment upgrade or a change in operational requirements.

An attempt to combine the advantages of a hand-held scanner and a stationary scanner was discloses in U.S. Pat. No. 5,767,501 to Schmidt assigned to the present assignee and incorporated in full by reference. U.S. Pat. No. 5,767,501 describes a hand-held scanner mounted in the head of a hand-supportable housing. The housing can also be supported in a separate base for hands-free presentation or countertop scanning. The base unit is mountable to a countertop, and is equipped with a pivoting receptacle. The pivoting receptacle permits the scanning window and, hence, the scanning pattern, to be adjustable about a horizontal axis. Unfortunately, the mounting of the base to the countertop requires modification to the countertop and irreversible damage to the countertop if the scanner system was ever removed due to an equipment upgrade or a change in operational requirements.

Thus, there is a great need in the bar code symbol reading art for a bar code symbol reading system, apparatus and stand which overcomes the above described shortcomings and drawbacks of prior art techniques, while providing greater versatility in its use. A need remains for a scanner configuration that can be secured to a POS countertop, which does not require modification or irreversible damage to the countertop.

### OBJECTS AND SUMMARY OF THE PRESENT INVENTION

Accordingly, a primary object of the present invention is to provide a novel optical bar code symbol reading system for mounting a bar code symbol reading device to a surface, which avoids the shortcomings and drawbacks of prior art systems.

Another object of the present invention is to provide a novel apparatus for mounting a bar code scanner to a flat surface without the use of hardware, which avoids the shortcomings and drawbacks of prior art apparatus.

Another object of the present invention is to provide a novel bar code scanning system, comprising a bar code scanner; and a suction-cup apparatus fastened to said bar code scanner, which avoids the shortcomings and drawbacks of prior art bar code scanning systems.

Another object of the present invention is to provide a novel stand that is rigidly connected to a mounting apparatus for mounting a bar code scanner to a flat surface without the use of hardware, which avoids the shortcomings and drawbacks of prior art stands.

Another object of the present invention is to provide a RFID point-of-sale scanning system, comprising a RFID reader; and a suction-cup apparatus fastened to said RFID reader.

These and other objects of the present invention will become apparently understood hereinafter and in the Claims to Invention appended hereto.

### BRIEF DESCRIPTION OF THE DRAWINGS OF PRESENT INVENTION

For a more complete understanding of how to practice the Objects of the Present Invention, the following Detailed Description of the Illustrative Embodiments can be read in conjunction with the accompanying Drawings, briefly described below.

FIG. 1 is an elevated side view of the optical bar code symbol reading system associated with a first illustrated embodiment of the instant invention;

FIG. 1a is an elevated side view of the optical bar code symbol reading system associated with a first illustrated embodiment of the instant invention, showing components associated with its pivoting receptacle;

FIG. 1b is a perspective exploded front view of the optical bar code symbol reading system associated with a first illustrated embodiment of the instant invention;

FIG. 1c is an elevated side view of the rigid connector associated with a first illustrated embodiment of the instant invention, showing components associated with its releasable-attachable base;

FIG. 1d is a cut away side view of the releasable-attachable base associated with a first embodiment of the instant invention;

FIG. 2 is an elevated front view of the bar code scanning system associated with a second illustrated embodiment of the instant invention;

FIG. 2a is an elevated side view of the bar code scanning system associated with a second illustrated embodiment of the instant invention;

FIG. 3 is a perspective exploded front view of the bar code scanning system associated with a second illustrated embodiment of the instant invention;

FIG. 3a is a perspective front view of the base associated with a second embodiment of the instant invention;

FIG. 3b is a cut away side view of the releasable-attachable base associated with a second embodiment of the instant invention;

FIG. 4 is a perspective front view of the bar code scanning system associated with a third illustrated embodiment of the instant invention;

FIG. 4a is a perspective front view of the rigid connector associated with a third illustrated embodiment of the instant invention;

FIG. 5 is an elevated front view of a stand device associated with a fourth illustrated embodiment, showing components associated with a quad suction-cup design of the instant invention;

FIG. 5a is an elevated side view of a stand device associated with a fourth illustrated embodiment, showing components associated with a quad suction-cup design of the instant invention;

FIG. 5b is an elevated side view of the rigid connector associated with a fourth illustrated embodiment of the instant invention;

FIG. 6 is an elevated side view of a POS bar code symbol reading system; and

FIG. 6a is an elevated side view of a POS bar code symbol reading system.

### DETAILED DESCRIPTION OF THE ILLUSTRATIVE EMBODIMENTS OF THE PRESENT INVENTION

Referring to the figures in the accompanying Drawings, the various illustrative embodiments of the instant invention will be described in great detail, wherein like elements will be indicated using like reference numerals.

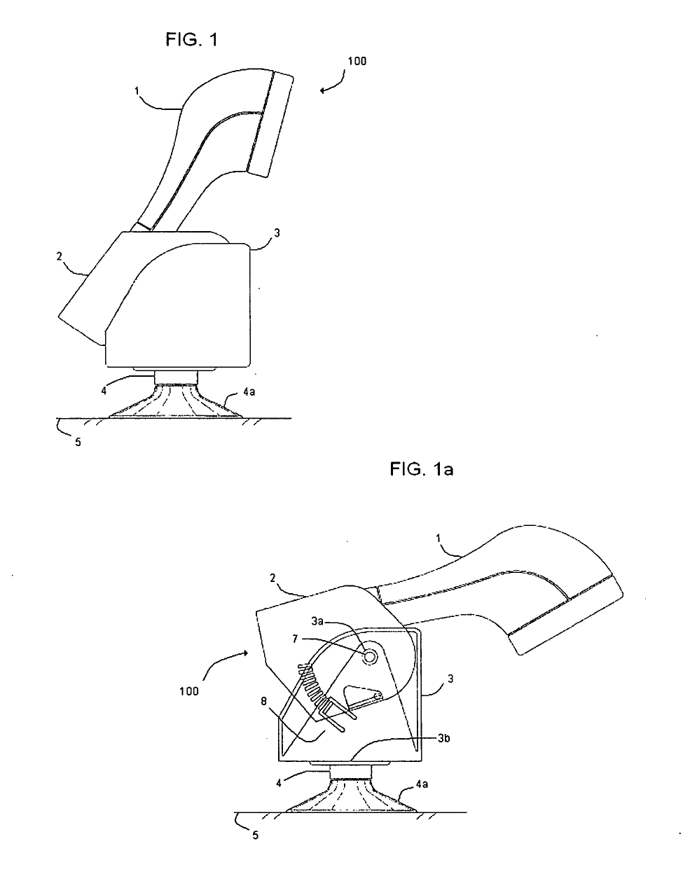

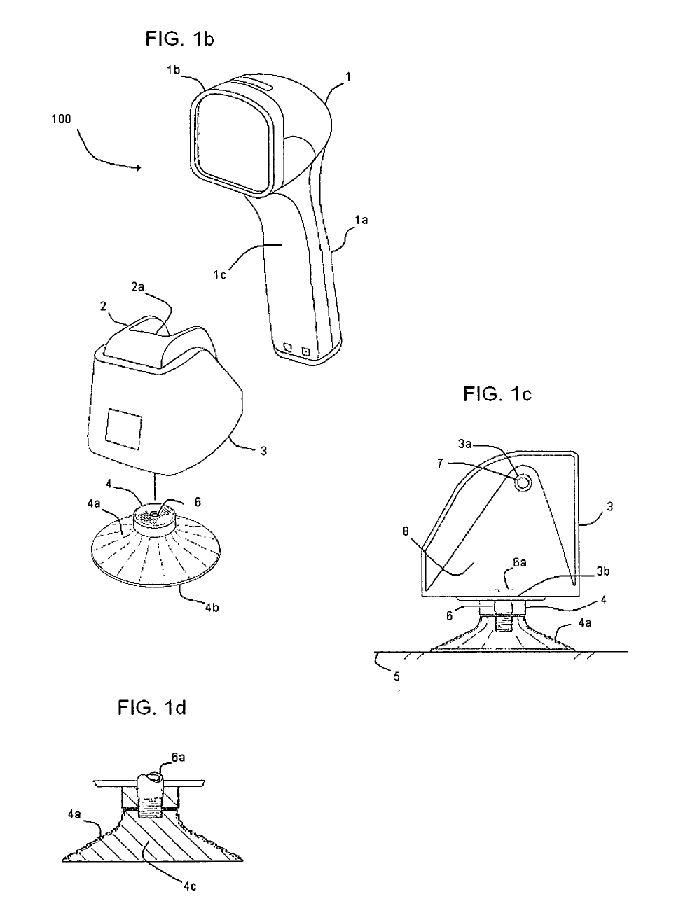

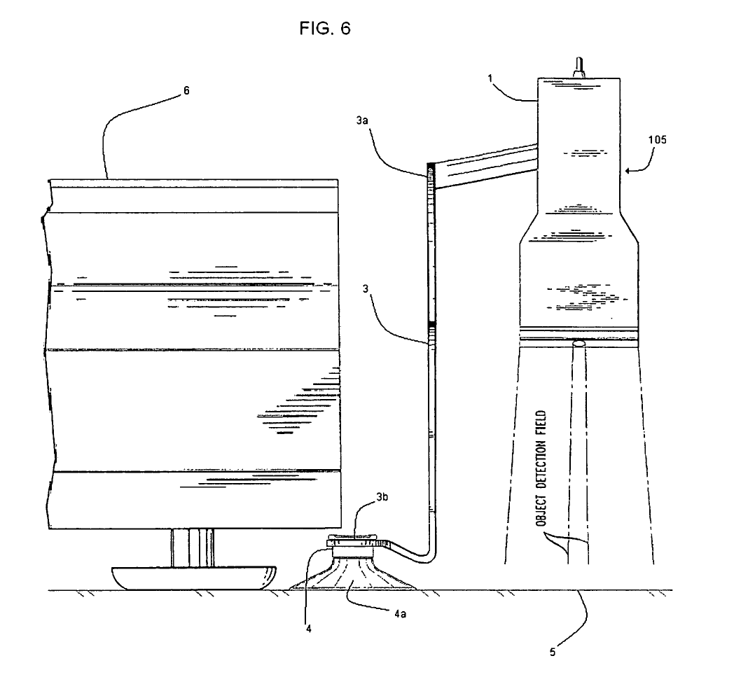

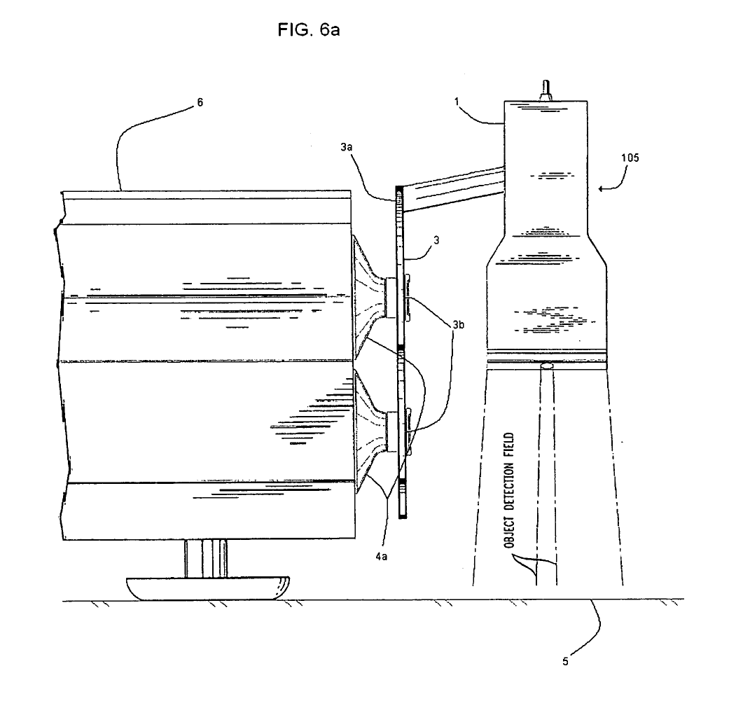

As shown in FIGS. 1 through 1d, a bar code reading system 100, according to the first illustrated embodiment of the instant invention, comprises a bar code scanner 1 operably associated with a cradle 2, a rigid connector 3 pivotally connected to said cradle 2 at first attachment point 3a, and a releasable-attachable base 4 mounted to said rigid connector 3 at a second attachment point 3b, wherein said releasable attachable base 4 is mounted to a flat surface 5 without modifying said flat surface 5. Bar code reading system 100 can be realized in a variety of different ways. For example, rigid connector 3 can be realized as a compact stand for support upon a countertop surface as shown FIG. 6, or it can be realized as a support for vertical wall-mounting as shown in FIG. 6a. In either embodiment, the function of rigid connector 3 is to support cradle 2 in any one of a plurality of positions relative to flat surface 5.

As illustrated in FIG. 1a, cradle 2 is pivotally supported with respect to rigid connector 3 by way of pivot pin 7. In order to hold cradle 2 relative to rigid connector 3 thereof in any one of a number of provided scanning positions, releasable stand-locking mechanism 8 is provided. Releasable stand-locking mechanism 8 was previously disclosed in U.S. Pat. No. 5,767,501 to Schmidt assigned to the present assignee and incorporated in full by reference.

As illustrated in FIG. 1b, cradle 2 is particularly adapted for receiving and supporting bar code scanner 1 without user support, thus providing a stationary, automatic hands-free mode of operation. In general, bar code scanner 1 includes an ultra-light weight hand supportable housing 1a, having head portion 1b and contoured handle portion 1c, whereby inner surface 2a of cradle 2 is formed to receive handle portion 1c.

As illustrated in FIGS. 1c and 1d, releasable-attachable base 4 is mounted to rigid connector 3 at second attachment point 3b. The mounting means can be realized in a variety of different ways. FIGS. 1c and 1d illustrate a method wherein rigid connector 3 is mounted to releasable-attachable base 4 via mounting screw 6a threaded into mounting hole 6. In other embodiments this attachment means may be realized in the form of any suitable attachment means well known in the art, including an adhesive means, a welding means, a press fit means, etc. In either embodiment, the function of the mounting means is to securely mount rigid connector 3 to releasable-attachable base 4.

As shown in FIGS. 1 through 1d, releasable-attachable base 4 comprises suction-cup 4a. In use, suction cup 4a is placed on flat surface 5 and pressed forcible downward to create a suction force gripping flat surface 5. Suction-cup apparatus 4 is easily removed from flat surface 5 by releasing the suction force. The suction force can be released by interrupting the suction seal around suction cup lip 4b. Other methods of releasing suction-cup apparatus 4 can be realized in the form of a suction release mechanism (not shown) coupled to suction-cup 4a for providing a quick release of suction force from suction-cup 4a, and consequently quick release of flat surface 5, when the release mechanism is activated.

In other embodiments releasable-attachable base 4 may be realized in the form of complex single suction-cup and multiple suction-cup setups. For example U.S. Pat. No. 6,663,064 to Minelli et al., and incorporated in full by reference, discloses a releasable-attachable base mount, said mount having a suction cup and a movable cap positioned over said suction cup, wherein a sufficient downward pressure on said cap vacuum mounts said suction cup to said surface, said cap having a peripheral wall and an underside surface with a recess formed therein, said mount further including a biasing element seated within said recess of said cap for biasing said cap upwardly, wherein said biasing element is a spring and is fully hidden from view by said peripheral wall; a housing for covering at least a portion of said suction cup, wherein said cap is located above said housing; and a plunger having a base attached with said suction cup and a post extending upwardly from said base and said suction cup, wherein said post extends through an opening in said housing and attaches with said cap, wherein upward movement of said suction cup causes corresponding upward movement of said cap, and wherein said peripheral wall of said cap is provided with a distinguishing marking, wherein said peripheral wall is concealed by said housing when said cap is pressed downwardly and said suction cup is mounted to surface, and wherein said peripheral wall is visible above said housing when said suction cup raises from a fully mounted position. In an alternative embodiment, releasable-attachable base 4 may employ a releasable magnetic mounting means, whereby releasable-attachable base 4 may be mounted to a ferrous metal surface. In either embodiment, the function of releasable-attachable base 4 is to mount bar code reading system 100 to flat surface 5 in a way which does not require any modification or irreversible damage to flat surface 5.

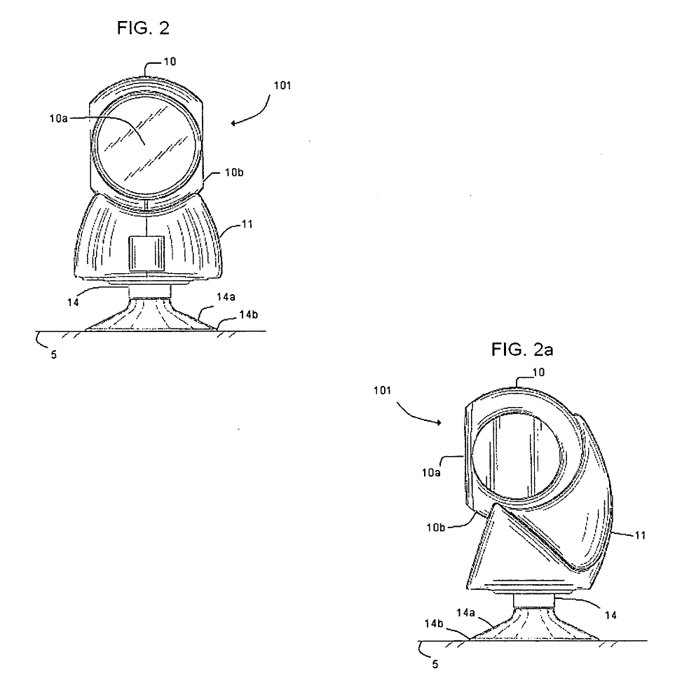

As shown in FIGS. 2 and 2a, a bar code reading system 101, according to the second illustrated embodiment of the instant invention, comprises a bar code scanning assembly 10a; a housing 10b for supporting said bar code scanning assembly 10a; a base 11 for supporting said housing 10b during hands-free mode of operation, base 11 being pivotably mounted to housing 10b; and a suction-cup apparatus 14 attached to base 11 for mounting bar code reading system 101 to flat surface 5, wherein suction-cup apparatus 14 is mounted to flat surface 5 without modifying flat surface 5. Bar code scanner 10 was previously disclosed in U.S. Pat. Application No. 2005/0040238 to Byun assigned to the present assignee and incorporated in full by reference.

Referring back to FIGS. 2 and 2a, suction-cup apparatus 14 is attached rigidly to base 11. The attachment means can be realized in the form of any suitable attachment means well known in the art, including an adhesive means, a welding means, a press fit means, etc. In either embodiment, the function of the attachment means is to securely mount base 11 to suction-cup apparatus 14.

As shown in FIGS. 2 through 2a, suction-cup apparatus 14 comprises suction-cup 14a. In use, suction cup 14a is placed on flat surface 5 and pressed forcible downward to create a suction force gripping flat surface 5. Suction-cup apparatus 14 is easily removed from flat surface 5 by releasing the suction force. The suction force can be released by interrupting the suction seal around suction cup lip 14b. Other methods of releasing suction-cup apparatus 14 can be realized in the form of a suction release mechanism (not shown) coupled to suction-cup 14a for providing a quick release of suction force from suction-cup 14a, and consequently quick release of flat surface 5, when the release mechanism is activated. In other embodiments suction-cup apparatus 14 may be realized in the form of complex single suction-cup and multiple suction-cup setups.

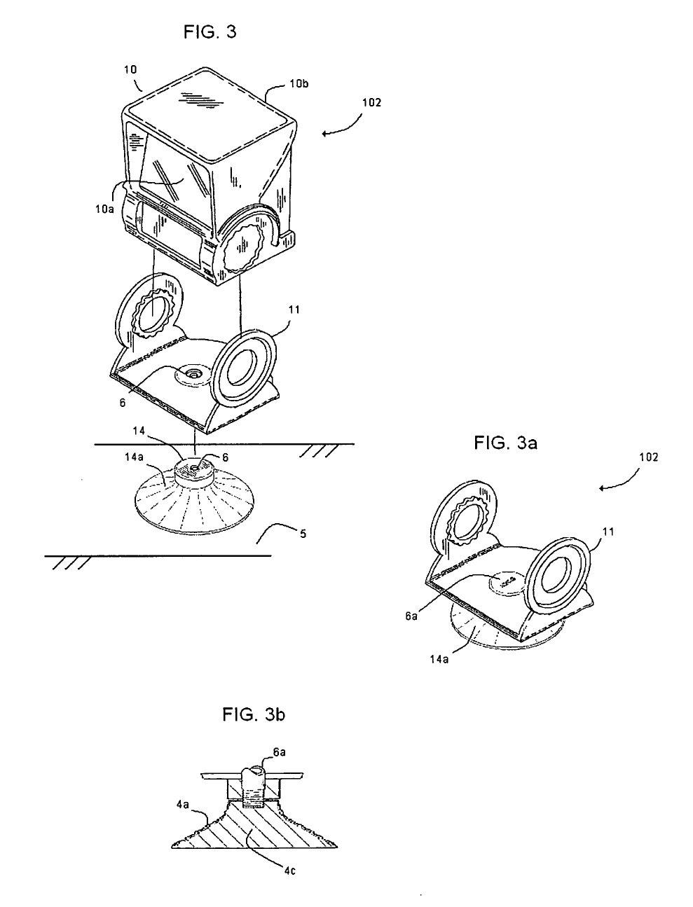

FIGS. 3 and 3a illustrates a bar code reading system 102 which is structurally similar to bar code reading system 101 of the instant invention. Bar code reading system 102, comprises a bar code scanning assembly 10a; a housing 10b for supporting said bar code scanning assembly 10a; a base 11 for supporting said housing 10b during hands-free mode of operation, base 11 being pivotably mounted to housing 10b; and suction-cup apparatus 14 attached to base 11 for mounting bar code reading system 102 to flat surface 5, wherein suction-cup apparatus 14 is mounted to flat surface 5 without modifying flat surface 5. Bar code scanner 10 was previously disclosed in U.S. Pat. Application No. 2005/0040238 to Byun assigned to the present assignee and incorporated in full by reference.

Referring back to FIGS. 3 and 3a, suction-cup apparatus 14 is attached rigidly to base 11. The attachment means can be realized in a variety of different ways. FIGS. 3 through and 3b, illustrate a method wherein base 11 is mounted to suction-cup apparatus 14 via mounting screw 6a threaded into mounting hole 6. In other embodiments this attachment means may be realized in the form of any suitable attachment means well known in the art, including an adhesive means, a welding means, a press fit means, etc. In either embodiment, the function of the attachment means is to securely mount base 11 to suction-cup apparatus 14.

As shown in FIGS. 3 through 3a, suction-cup apparatus 14 comprises suction-cup 14a. In use, suction cup 14a is placed on flat surface 5 and pressed forcible downward to create a suction force gripping flat surface 5. Suction-cup apparatus 14 is easily removed from flat surface 5 by releasing the suction force. The suction force can be released by interrupting the suction seal around suction cup lip 14b. Other methods of releasing suction-cup apparatus 14 can be realized in the form of a suction release mechanism (not shown) coupled to suction-cup 14a for providing a quick release of suction force from suction-cup 14a, and consequently quick release of flat surface 5, when the release mechanism is activated. In other embodiments suction-cup apparatus 14 may be realized in the form of complex single suction-cup and multiple suction-cup setups.

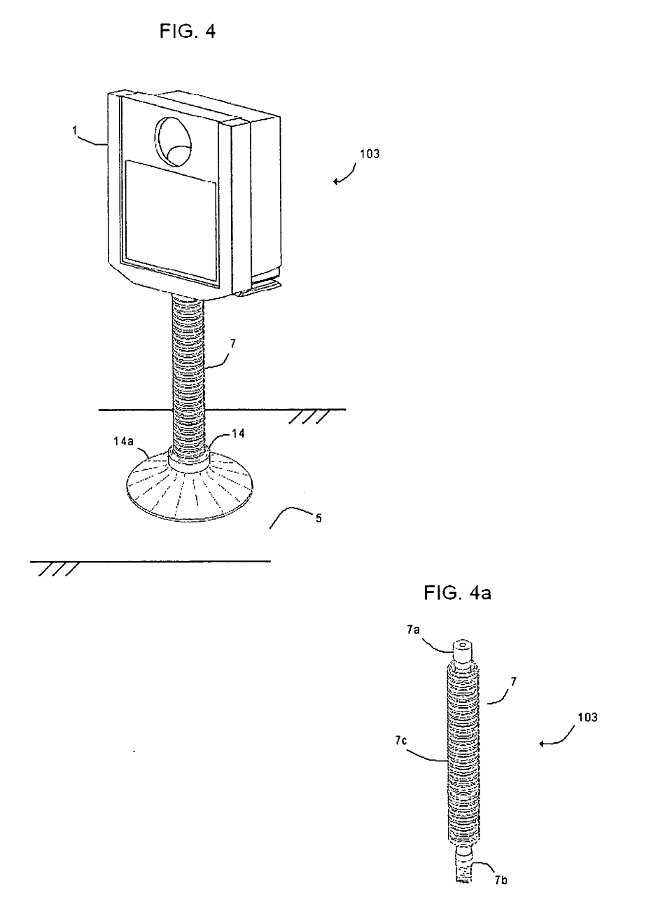

As shown in FIGS. 4 and 4a, bar code scanning system 103, according to the third illustrated embodiment of the instant invention, comprises a bar code scanner 1; a flex connector 7, said flex connector 7 further comprising a first end 7a and a second end 7b, wherein said first end 7a is rigidly connected to said bar code scanner 1; a suction-cup apparatus 14, said suction-cup apparatus 14 rigidly connected to said connector's second end 7b, wherein said suction-cup apparatus 14 is mounted to surface 5 without modifying surface 5 and can be removed without damaging surface 5.

As shown in FIG. 4a, flex connector 7 may comprise a gooseneck type flexible column, or other types of flexible column, such as the type with a plurality of pivot joints in different axis orientations. In certain design configurations, flex connector 7 is insulated by protective cover 7c. Protective cover 7c slips over flex connector 7 and protects flex connector 7 from debris, while not restricting its flexibility.

Referring back to FIG. 4 and FIG. 4a, suction-cup apparatus 14 is attached rigidly to second end 7b of flex connector 7. The attachment means can be realized in a variety of different ways.

As further shown in FIGS. 4 and 4a, suction-cup apparatus 14 comprises suction-cup 14a. In use, suction cup 14a is placed on flat surface 5 and pressed forcible downward to create a suction force gripping flat surface 5. Suction-cup 14a is easily removed from flat surface 5 by releasing the suction force. The suction force can be released by interrupting the suction seal around suction cup lip 14b. Other methods of releasing suction-cup 14a can be realized in the form of a suction release mechanism (not shown) coupled to suction-cup 14a for providing a quick release of suction force from suction-cup 14a, and consequently quick release of flat surface 5, when the release mechanism is activated. In other embodiments suction-cup apparatus 14 may be realized in the form of complex single suction-cup and multiple suction-cup setups.

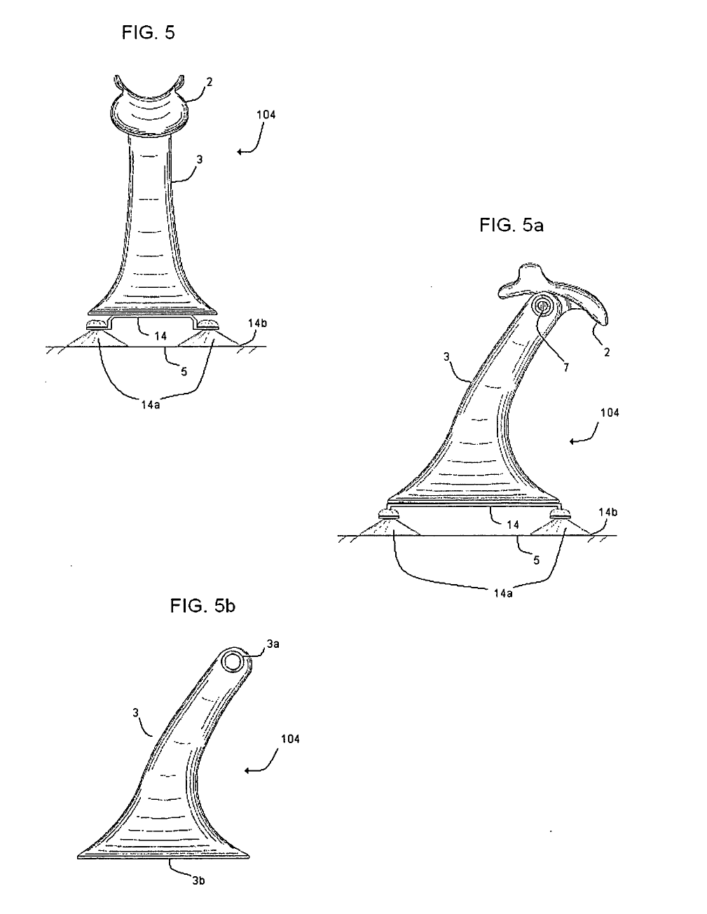

FIGS. 5 through 5b, according to the fourth illustrated embodiment of the instant invention, illustrate a stand 104 for mounting a bar code scanner (not shown) to surface 5. Stand 104 comprises a rigid connector 3, said rigid connector 3 further comprising a first end 3a and a second end 3b; a cradle 2 for securely holding a bar code scanner, said cradle mechanically connected to said rigid connector's first end 3a; a suction-cup apparatus 4 for mounting said stand 104 to a surface 5, said suction-cup apparatus 4 mechanically connected to said connector's second end 3b, wherein said suction-cup apparatus 4 is mounted to said surface 5 without modifying said surface 5. As illustrated in FIG. 5a, cradle 2 is pivotally supported with respect to rigid connector 3 by way of pivot pin 7 at first attachment point 3a. As illustrated in FIGS. 5 through 5b, cradle 2 is particularly adapted for receiving and supporting a bar code scanner without user support, thus providing a stationary, automatic hands-free mode of operation.

As shown in FIGS. 5 through 5a, suction-cup apparatus 14 comprises a plurality of suction-cups 14a. In use, suction cups 14a are placed on flat surface 5 and pressed forcible downward to create a suction force gripping flat surface 5. Suction-cup apparatus 14 is easily removed from flat surface 5 by releasing the suction force. The suction force can be released by interrupting the suction seal around each individual suction cup lip 14b. Other methods of releasing suction-cup apparatus 14 can be realized in the form of a suction release mechanism (not shown) coupled to each suction-cup 14a for providing a quick release of suction force from each suction-cup 14a, and consequently quick release of flat surface 5, when the release mechanism is activated. In other embodiments suction-cup apparatus 14 may be realized in the form of complex single suction-cup and multiple suction-cup setups.

FIGS. 6 and 6a illustrate two conceived POS systems. FIG. 6 discloses a system wherein rigid connector 3 is realized as a compact stand for support upon a countertop surface with releasable-attachable base 4 comprising a single horizontally mounted suction-cup 4a. Releasable-attachable base 4 is position in close proximity to cash register 6. FIG. 6a discloses a system wherein rigid connector 3 is realized as a compact stand for support upon a countertop surface with releasable-attachable base 4 comprising two vertically mounted suction-cups 4a. Releasable-attachable base 4 is mounted directly on cash register 6, therefore freeing up countertop space.

It should be clear that the bar code symbol reading scanner associated with the system, apparatus, and stand of the instant invention may encompass a wide array of technologies. For example, the bar code symbol reading scanner may be capable of reading one-dimensional bar code symbols, the bar code symbol reading scanner may be capable of reading two-dimensional bar code symbols, the bar code symbol reading scanner may be an omni-directional bar code symbol scanner, the bar code symbol reading scanner may be handheld, the bar code symbol reading scanner may be a single-line laser scanning system, the bar code symbol reading device may be an image based bar code device, the bar code symbol reading scanner may be a charged-coupled device (CCD), or the bar code symbol reading device may be a combination thereof. Since many possible embodiments may be made of the invention without departing from the scope thereof, it is to be further understood that the bar code reader in some instance may be substituted with a RFID reader and still deemed to be within the scope of the present invention.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

1. An optical bar code symbol reading system for mounting a bar code symbol reading device to a surface, said system comprising:
a bar code symbol reading device;
a cradle for securely holding said bar code symbol reading device; and
a releasable-attachable base rigidly connected to said cradle, wherein said releasable-attachable base is mounted to said surface-without modifying said surface.

2. The system as in claim 1, wherein said bar code symbol reading device is capable of reading one-dimensional bar code symbols.

3. The system as in claim 1, wherein said bar code symbol reading device is capable of reading two-dimensional bar code symbols.

4. The system as in claim 1, wherein said bar code symbol reading device is an omni-directional bar code symbol reader.

5. The system as in claims 1, wherein said bar code symbol reading device is handheld.

6. The system as in claim 1, wherein said bar code symbol reading device is a single-line laser scanning device.

7. The system as in claim 1, wherein said bar code symbol reading device is an image based bar code reader.

8. The system as in claim 7, wherein said bar code symbol reading device utilizes charge-coupled device (CCD) image sensing/detecting technology.

9. The system as in claim 1, wherein said releasable-attachable base is mounted to said surface via a suction-cup.

10. The system as in claim 1, wherein said releasable-attachable base is mounted to said surface via a plurality of suction-cups.

11. (canceled)

12. An apparatus for mounting a bar code scanner to a surface, said apparatus comprising:
a cradle for securely holding said bar code scanner; and
a releasable-attachable base rigidly connected to said cradle, wherein said releasable-attachable base is mounted to said surface without modifying said surface.

13. The apparatus as in claim 12, wherein said bar code scanner is capable of reading one-dimensional bar codes.

14. The apparatus as in claim 12, wherein said bar code scanner is capable of reading two-dimensional bar codes.

15. The apparatus as in claim 12, wherein said bar code scanner is an omni-directional bar code scanner.

16. The apparatus as in claim 12, wherein said bar code scanner is handheld.

17. The apparatus as in claim 12, wherein said bar code scanner is a single-line laser scanning device.

18. The apparatus as in claim 12, wherein said bar code scanner is an image based bar code scanner.

19. The apparatus as in claim 18, wherein said bar code scanner utilizes charge-coupled device (CCD) image sensing/detecting technology.

20. The apparatus as in claim 12, wherein said releasable-attachable base is mounted to said surface via a suction-cup.

21. The system as in claim 1, wherein said releasable-attachable base is mounted to said surface via a plurality of suction-cups.

22. (canceled)

23. A bar code scanning system, comprising
a bar code scanning assembly;
a housing for supporting said bar code scanning assembly;
a base for supporting said housing during hands-free mode of operation, the base being pivotably mounted to said housing; and
a suction-cup apparatus attached to said base for mounting said bar code scanning system to a surface, wherein said suction-cup apparatus is mounted to said surface without modifying said surface.

24. The bar code scanning system as in claim 23, wherein said system is capable of reading one-dimensional bar codes.

25. The bar code scanning system as in claim 23, wherein said system is capable of reading two-dimensional bar codes.

26. The bar code scanning system as in claim 23, wherein said system is capable of omni-directional scanning.

27. The bar code scanning system as in claim 23, wherein said system is capable of single-line laser scanning device.

28. The bar code scanning system as in claim 23, wherein said system is capable of image based bar code scanning.

29. The bar code scanning system as in claim 28, wherein said image based bar code scanning utilizes charge-coupled device (CCD) image sensing/detecting technology.

30. A bar code scanning system, comprising:
a bar code scanner;
a flex connector, said flex connector further comprising a first end and a second end, wherein said first end is rigidly connected to said bar code scanner;
a suction-cup apparatus, said suction-cup apparatus rigidly connected to said connector's second end, wherein said suction-cup apparatus is mounted to a surface without modifying said surface and can be removed without damaging said surface.

31. The bar code scanning system as in claim 30, wherein said suction-cup apparatus comprises a suction-cup.

32. The bar code scanning system as in claim 30, wherein said suction-cup apparatus comprises a plurality of suction-cups.

33. The bar code scanning system as in claim 30, wherein said bar code scanner is capable of reading one-dimensional bar codes.

34. The bar code scanning system as in claim 30, wherein said bar code scanner is capable of reading two-dimensional bar codes.

35. The bar code scanning system as in claim 30, wherein said bar code scanner is an omn-directional bar code scanner.

36. The bar code scanning system as in claim 30, wherein said bar code scanner is a single-line laser scanning device.

37. The bar code scanning system as in claim 30, wherein said bar code scanner is an image based bar code scanner.

38. The bar code scanning system as in claim 37, wherein said bar code scanner utilizes charge-coupled device (CCD) image sensing/detecting technology.

39. A stand for mounting a bar code scanner to a surface, comprising:
a rigid connector, said rigid connector further comprising a first end and a second end;
a cradle for securely holding said bar code scanner, said cradle mechanically connected to said rigid connector's first end;
a suction-cup apparatus for mounting said stand to said surface, said suction-cup apparatus mechanically connected to said connector's second end, wherein said suction-cup apparatus is mounted to said surface without modifying said surface.

40. The stand as in claim 39, wherein said suction-cup apparatus comprises a single suction-cup.

41. The stand as in claim 39, wherein said suction-cup apparatus comprises a plurality of suction-cups.

42. A bar code scanning system, comprising;
a bar code scanner; and
a suction-cup apparatus fastened to said bar code scanner.

43. The bar code scanning system as in claim 42, wherein said suction-cup apparatus comprises a suction-cup.

44. The bar code scanning system as in claim 42, wherein said suction-cup apparatus comprises a plurality of suction-cups.

45. The bar code scanning system as in claim 42, wherein said bar code scanner is capable of reading one-dimensional bar codes.

46. The bar code scanning system as in claim 42, wherein said bar code scanner is capable of reading two-dimensional bar codes.

47. The bar code scanning system as in claim 42, wherein said bar code scanner is an omni-directional bar code scanner.

48. The bar code scanning system as in claim 42, wherein said bar code scanner is a single-line laser scanning device.

49. The bar code scanning system as in claim 42, wherein said bar code scanner is an image based bar code scanner.

50. The bar code scanning system as in claim 49, wherein said bar code scanner utilizes charge-coupled device (CCD) image sensing/detecting technology.

51. A RFID point-of-sale scanning system, comprising:
a RFID reader; and
a suction-cup apparatus fastened to said RFID reader.

52. The system as in claim 51, wherein said suction-cup apparatus comprises a suction-cup.

53. The system as in claim 51, wherein said suction-cup apparatus comprises a plurality of suction-cups.
